(19) United States
(12) Patent Application Publication
(10) Pub. No.: US 2003/0227703 A1
(43) Pub. Date: Dec. 11, 2003

(54) Hard disk drive with application-specific components

(75) Inventor: Foster D. Hinshaw, Somerville, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Netezza Corporation, Framingham, MA

(21) Appl. No.: 10/164,719

(22) Filed: Jun. 6, 2002

(51) Int. Cl. G11B 5/02

(52) U.S. Cl. 360/55

(57) ABSTRACT

A hard disk drive (HDD) comprising an additional application-specific component for receiving and executing application-specific instructions. Standard ATA or SCSI hard disk drives comprise, at a minimum, a housing, rotating disk platters containing data, magnetic heads to read and write data to the rotating disks, and a controller circuit for operating the rotation of the disk and read/write functions of the magnetic heads. An additional component is added to this standard list of components, the additional component being capable of receiving application-specific instructions via a standard network connection and executing these application-specific instructions on the data contained on the rotating disks. The application-specific component may be in the form of an add-on board which couples to the controller circuit or, alternatively, in the form of an application-specific chip which mates with a socket provided on the controller circuit.

### BACKGROUND OF THE INVENTION

The present invention relates generally to hard disk drives and more particularly to an application-specific interface.

In many computer applications, Hard Disk Drives (HDDs) are often arranged in arrays. Such arrays are to be used to implement large-scale databases, web servers, streaming media servers and other applications requiring centralized storage of large amounts of data. In the typical approach, HDDs are designed to be coupled to system components via a standard controller interface. For example, this interface may be an AT Attachment (ATA) interface or a Small Computer System Interface (SCSI) interface.

Performance improvements for specific applications can result if application-specific components are located in close proximity to the HDDs. The application-specific components can perform application-specific tasks, such as database operations, using data on the HDDs and return results to a local host or even a remote host via a network. Current methods of integrating an application-specific component include providing an application-specific circuit board that connects to the HDD via the standard ATA or SCSI interface port, and connects to the host computer via local bus or via a network interface such as an Ethernet connection.

Typically, the HDD and application-specific circuit board are mounted together inside of a larger housing, such as a sled module. However, the design and manufacturing of such a sled module creates additional expenses. Manufacturers and system integrators who seek to use application-specific circuits must also account for these sled modules (or other HDDs with application-specific circuit board enclosures) when designing new hardware to house the array of HDDs for their application. The sled modules also create additional physical space requirements, as they are typically twelve inches in length or more, twice the length of a HDD alone.

### SUMMARY OF THE INVENTION

It would thus be beneficial if HDD's were designed mechanically and electrically in such a way as to be capable of receiving application-specific circuit components on or within the housing of the HDD itself. This would permit the application-specific component to be packaged with and coupled directly to the HDD, thus making HDDs easily customizable to specific end-uses, such as database operations. The resulting unit could be of the same or similar physical dimensions as industry standard HDDs and thus require little or no physical modifications to be adaptable to standard computer system configurations. The resulting unit could also retain the same electrical interfaces as industry standard HDDs and thus require no electrical modifications to current computer systems.

An HDD manufacturer would also be able to sell the same device to every end user and system integrator whether or not they actually need the application-specific features. End users who do not have application-specific needs can simply use the unit just as they used previous standard HDDs. Manufacturers or system integrators can then provide their own application-specific component as needed and resell the package as an application-specific HDD.

In a standard HDD assembly, there is a housing, rotating disk platters of mass storage media, magnetic heads for writing and reading data to and from the rotating disks, an interface for receiving a control signal, and a controller circuit board for controlling the reading and writing of data to the disks. The present invention adds to this standard HDD assembly an application-specific circuit component for receiving and executing application-specific instructions. The controller circuit board and application-specific components can be positioned adjacent to each other, stacked one on top of the other, or integrated with one another, depending on the particular HDD's configuration. They can interface with each other via a standard ATA or SCSI interface or any other suitable interface, including a proprietary interface.

Examples of the application-specific component include a circuit board or an integrated circuit such as an Application Specific Integrated Circuit (ASIC), Field Programmable Gate Array (FPGA), Central Processing Unit (CPU), or Digital Signal Processor (DSP).

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A and 1B are top and cross-sectional views, respectively, of a typical HDD configuration.

FIGS. 2A and 2B are top and cross-sectional views, respectively, of a HDD having a controller circuit coupled to an application-specific component.

FIGS. 3A and 3B are top and cross-sectional views, respectively, of second configuration of a HDD having a controller circuit coupled to an application-specific component.

FIGS. 4A and 4B are top and cross-sectional views, respectively, of a third configuration of a HDD having a controller circuit coupled to an application-specific component.

FIGS. 5A and 5B are top and cross-sectional views, respectively, of a HDD having a controller circuit which has sockets to receive application-specific chips.

### DETAILED DESCRIPTION OF THE INVENTION

A description of preferred embodiments of the invention follows.

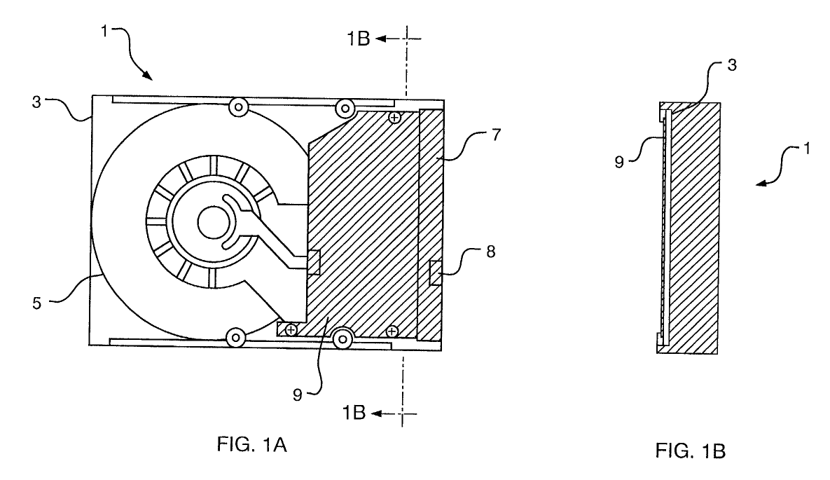

FIGS. 1A and 1B show a typical HDD configuration. A standard HDD 1 has a housing 3, one or more rotating disk platters 5, a controller circuit 9, and an industry standard connector 7 such as an American National Standards Institute (ANSI) AT Attachment interface (ATA), commonly referred to as the Integrated Drive Electronics (IDE) interface, and power supply connector 8. Although this description may only refer to ATA interfaces and connectors throughout, it is understood that such connectors can be IDE, SCSI, Serial ATA, Fibre Channel Arbitrated Loop (FC-AL) (optical), or any other HDD connector. The housing 3, for example, fits the industry standard 3.5 inch disk form factor. Other embodiments may have other form factors. Standard HDD assemblies have a disk controller circuit 9 for receiving control signals and operating the magnetic heads which read and write data to the disk platter 5 in a manner which is well known in the art. Although the ATA connectors may not be needed when the HDD is used in conjunction with an application-specific circuit board, they may be included so that HDD manufacturers can reduce the extent to which HDD form factors must be changed in order to accommodate an application-specific circuit board.

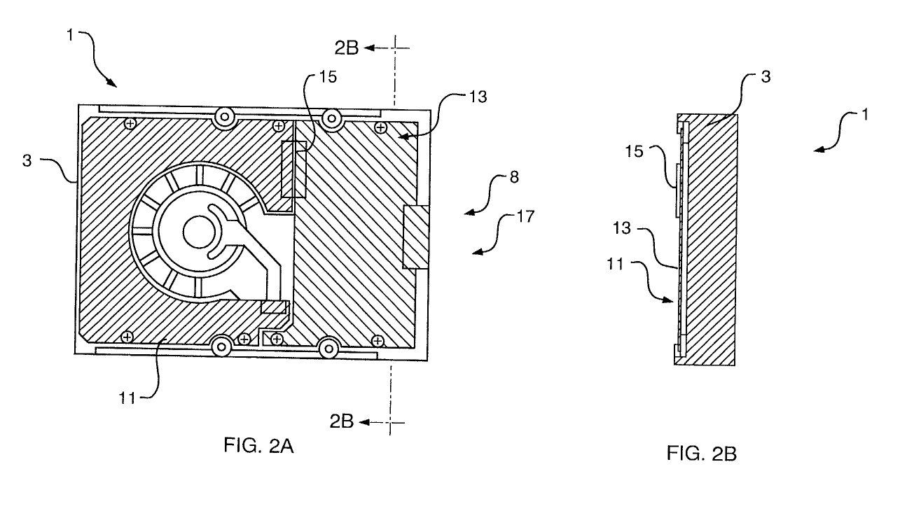

FIGS. 2A and 2B show a first configuration of the present invention. An HDD 1 has a housing 3, a new style controller circuit 11 secured to the housing 3, and an application-specific circuit board 13 coupled to the controller circuit 11 by a new ATA connector 15, the application-specific circuit board also being secured to the housing 3. By “coupled,” it is meant that the application-specific circuit board 13 is in electrical communication with the controller circuit 11 in such a way that power or signal information may be transferred from one to the other. This configuration may also comprise a connector 17 for communicating with a network such as an Ethernet connector. A power supply connector 8 may also be located on the rear side of the housing 3. Alternatively, power supply connector 8 and connector 17 may be combined into a single unified connector. The application-specific component 13 is for performing application-specific functions as programmed by any manufacturer or end-user. Note most significantly that disk functionality and application functionality are separated so that the application functionality is easily modifiable. As a result, disk functionality and application functionality can have independent vendors and independent development cycles.

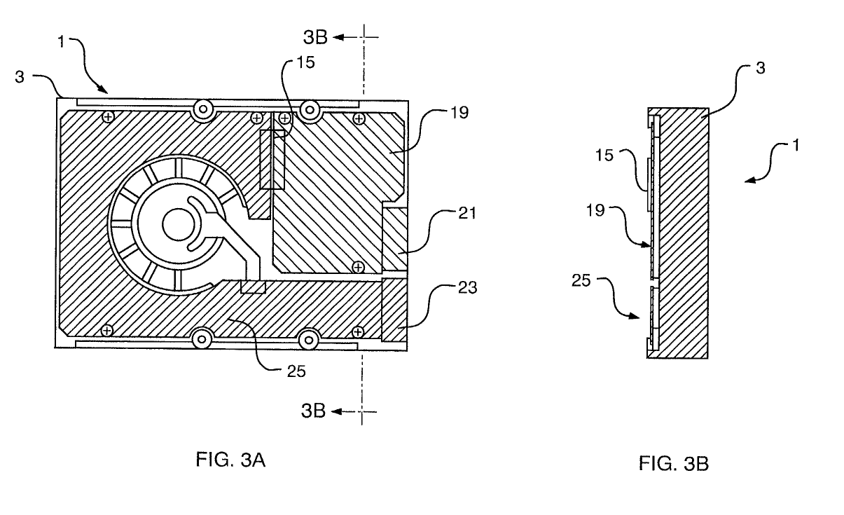

FIGS. 3A and 3B show a second possible configuration of the present invention. This configuration is similar to that of FIGS. 2A and 2B, except for a slightly different configuration of the new controller circuit 25 and new application-specific board 19. In this configuration, the controller circuit 25 extends all the way to the back of the HDD 1 on one side of the housing 3. At the end of the controller circuit 25 resides a standard power connector 23. The application-specific board 19, accordingly, is narrower so as to fit into the remaining space on the housing 3. An application-specific connector 21, such as a 9-pin Ethernet connector, may be coupled to the application-specific board 19. In this embodiment, the application-specific board 19 and controller circuit 25 may still be connected via a standard ATA connector 15.

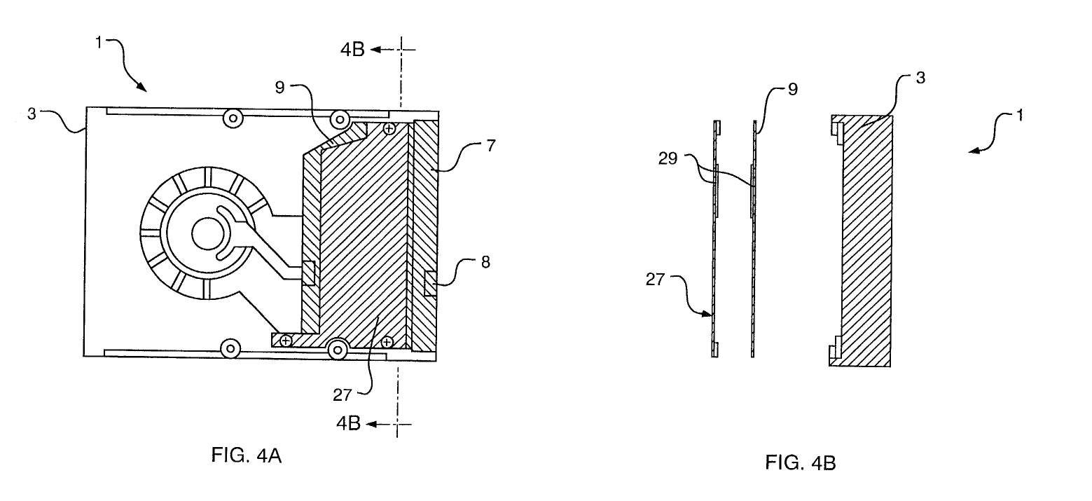

FIGS. 4A and 4B show a third possible configuration for the present invention. In this embodiment, an application-specific board 27 resides on top of the standard controller circuit 9. The application-specific board 27 plugs into the standard controller circuit 9 via electrical connections 29. This configuration may also comprise a standard ATA connector 7 and power supply connector 8 on the backside of the housing 3.

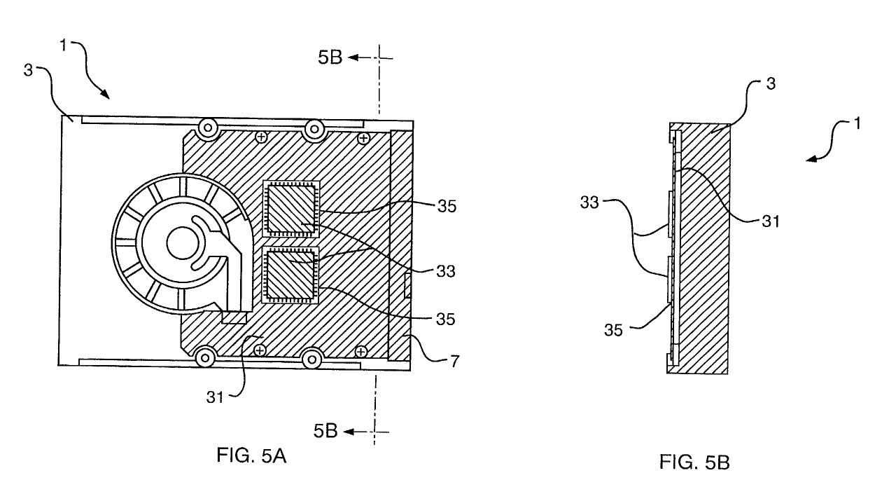

FIGS. 5A and 5B show a fourth possible configuration of the present invention. In this embodiment, there is no application-specific board. Rather, the controller circuit 31 has one or more sockets 35 for receiving application-specific chips 33. The HDD may also have a standard ATA connector 7, power supply connector (not shown) and/or a network connection (not shown) as in the previous embodiments. Alternatively, the pins of the ATA connector may be reassigned to provide power and network functions. It may also be desirable to have one of the sockets 35 capable of receiving a memory chip to aid the application-specific chip 33 in its operations.

The exact physical juxtaposition of the application-specific component (board or chip) and HDD controller circuit may depend on the specific HDD manufacturer's preferred configuration of the rest of the HDD assembly. However, no specific configuration of the two components is required of the present invention. HDD manufacturers need only create HDDs having a housing and a controller circuit which allows for the addition of an application-specific component. To make the HDD operational as a standard form factor HDD, manufacturers can provide a “dummy” card in place of an application-specific circuit board. Such a dummy card can simply provide a standard connector port on the rear of the HDD housing where it would normally be and connect that port to the controller circuit. Thus, the HDD can function normally without the presence of an application-specific component.

Likewise, the arrangement of the various connectors is also flexible. The HDD may have a power supply connector, a standard ATA connector and a network connector such as an Ethernet port. These ports may be coupled to the controller circuit and/or the application-specific component. A network connector also need not be present. In such a case, the application-specific component may utilize the standard controller port, such as the ATA connector, for outputting data. The HDD may have a simple jumper switch for selecting the output signal to the external connector as being either a standard ATA configuration or an application-specific configuration. As data comes off the disk, if an application-specific component is present, the data is processed by the application-specific component and output to the connector in whichever configuration is selected by the jumper. The connector ports and power ports may also be unified into a single port.

Most significantly, however, these arrangements permit a manufacturer of disk drives to provide a platform which can be easily customized for specific end users. The disk manufacturer can make the same common assembly for different end users, such as for both a database end user and a web server end user. A database manufacturer or system integrator can then add their customized application-specific circuit board to the assembly. Likewise, a web server manufacturer or system integrator can add an application-specific circuit board customized for serving web pages. This may further be explained in the context of a database application. For example, for a large-scale database application, consider an array of HDDs having a controller circuit and a database-specific component coupled to the controller circuit. The database-specific component also has a network interface port, for example an Ethernet port, which extends out of the back of the housing of the HDD. When the HDD is mounted in a tray or rack, the network interface port mates with a corresponding port in the back of the tray or rack, thus electrically coupling the database-specific component to the network or server computer. A central database host may then provide database query instructions over the network port, such as a select operation. The select instruction is received by the database-specific component, which processes the instruction specifically carrying the appropriate control signals to the HDD's control circuit to read requested records from the disk. Once the records are retrieved, the database-specific component performs the requested select operation on the retrieved records, obtaining a result for the operation. The database-specific component can then send back the results of the database operation to the host. Communication between the database-specific component and the database server can all be in the appropriate database language, SQL for example, obviating the need for the sever to take separate steps to communicate with the actual HDD's which house the databases.

While this invention has been particularly shown and described with references to preferred embodiments thereof, it will be understood by those skilled in the art that various changes in form and details may be made therein without departing from the scope of the invention encompassed by the appended claims.

What is claimed is:

1. A hard disk drive comprising:
a housing;
mass storage media located in the housing for storing data;
a controller circuit coupled to the housing and for controlling the reading and writing of data to the mass storage media; and
an application-specific component coupled to the housing and controller circuit and having application-specific programming for executing application-specific instructions.

2. The hard disk drive of claim 1 wherein the housing has physical dimensions corresponding to a recognized industry standard disk drive form factor.

3. The hard disk drive of claim 1 wherein the controller circuit and application-specific component are located adjacent to each other.

4. The hard disk drive of claim 1 where the application-specific component comprises a circuit board having application-specific electrical components.

5. The hard disk drive of claim 1 where the application-specific component comprises an Application-Specific Integrated Circuit (ASIC).

6. The hard disk drive of claim 1 wherein the application-specific component is located on top of the controller circuit.

7. The hard disk drive of claim 1 wherein the controller circuit and application-specific component are coupled via an ATA interface.

8. The hard disk drive of claim 1 wherein controller circuit and application-specific component are coupled via a SCSI interface.

9. The hard disk drive of claim 1 wherein controller circuit and application-specific component are coupled via a Serial ATA interface.

10. The hard disk drive of claim 1 wherein controller circuit and application-specific component are coupled via an FC-AL interface.

11. The hard disk drive of claim 1 wherein the application-specific component comprises an interface connector for communicating with a computer network.

12. The hard disk drive of claim 1 further comprising an Ethernet connector.

13. The hard disk drive of claim 1 further comprising a connector port and a power port.

14. The hard disk drive of claim 13 wherein the connector port and power port are combined into a unified port.

15. The hard disk drive of claim 14 wherein the unified port is made by reassigning the pins of a single port to serve data and power supply functions.

16. A method for processing data on a hard disk drive comprising:
providing a hard disk drive comprising a housing, mass storage media located in the housing for storing data, a controller circuit coupled to the housing controlling the reading and writing of data to the mass storage media, and an application-specific component coupled to the housing, electrically connected to the controller circuit and containing application-specific programming for executing application-specific instructions;
transmitting an application-specific instruction from a host computer to the application-specific component;
the application-specific component receiving the application-specific instruction processing the application-specific instruction; and
the application-specific component returning results of the instruction to the server.

17. The method of claim 16 wherein the housing has physical dimensions corresponding to a recognized industry standard disk drive form factor.

18. The method of claim 16 wherein the controller circuit and application-specific component are electrically coupled via an ATA interface.

19. The method of claim 16 wherein the controller circuit and application-specific component are electrically coupled via a SCSI interface.

20. The method of claim 16 wherein controller circuit an application-specific component are electrically coupled via a Serial ATA interface.

21. The method of claim 16 wherein controller circuit and application-specific component are electrically coupled via an FC-AL interface.

22. A hard disk drive comprising:
a housing;
mass storage media located in the housing for storing data;
a controller circuit coupled to the housing controlling the reading and writing of data to the mass storage media, the controller circuit having a socket for receiving an application-specific chip; and
an application-specific chip coupled to the socket and containing application-specific programming for executing application-specific instructions.

23. The hard disk drive of claim 22 wherein the housing has physical dimensions corresponding to a recognized industry standard disk drive form factor.

24. The hard disk drive of claim 22 wherein the controller circuit further comprises a socket for receiving a memory chip.
